(19) United States
(12) Patent Application Publication
(10) Pub. No.: US 2025/0100588 A1
(43) Pub. Date: Mar. 27, 2025

(54) Method for Determining a Hands-Off Time for an Automated Motor Vehicle

(71) Applicant: Bayerische Motoren Werke Aktiengesellschaft, Muenchen (DE)

(72) Inventors: Mathias DOELL, Unterschleissheim (DE); Ivo NIKOLOV, Muenchen (DE); Stefan PILZ, Putzbrunn (DE); Christoph RESCH, Obernzell (DE); Jakob REUTER, Muenchen (DE)

(21) Appl. No.: 18/576,800

(22) PCT Filed: Jul. 5, 2022
(86) PCT No.: PCT/EP2022/068541

§ 371 Date: Jan. 5, 2024

(51) Int. Cl. B60W 60/00; B60W 10/20; B60W 30/12; B60W 40/08; B60W 40/09

(52) U.S. Cl. CPC B60W 60/0057; B60W 10/20; B60W 30/12; B60W 40/09; B60W 2040/0827; B60W 2420/403; B60W 2420/54; B60W 2540/225; B60W 2540/229

(57) ABSTRACT

A method determines a hands-off time for an automated motor vehicle, wherein the hands-off time is determined on the basis of a degree of attentiveness of a driver of the motor vehicle over the time.

### BACKGROUND AND SUMMARY

The present invention relates to a method for determining a hands-off time for an automated motor vehicle and to a control unit designed to carry out the method.

DE 10 2018 129 804 A1 discloses a method for providing information regarding a required alertness level of a driver of a vehicle. This comprises selecting a required alertness level from a number of possible alertness levels, wherein the alertness level defines a required alertness of the driver for driving the vehicle, ascertaining an associated period describing the amount of time for which the required alertness level is required, and providing a signal that describes the required alertness level and the associated period.

DE 10 2014 220 759 A1 discloses a method for monitoring an alertness level of a driver of a vehicle, wherein a length of time is determined on the basis of a speed of the vehicle. It is determined whether an eyelid closure time and/or an eyelid closing time of the driver exceeds the determined length of time.

DE 10 2008 056 343 A1 discloses a warning system for a motor vehicle, comprising sensor means for detecting a driving situation, a warning device for outputting a warning to a driver of the motor vehicle, a device for detecting the state of alertness of the driver, which comprises operator control elements for available vehicle components, and a control device that takes data from the sensor means and the device for detecting the state of alertness as a basis for actuating the warning device. In this warning system, the device for detecting the state of alertness infers that the alertness level of the driver is decreased if the total duration of a sequence comprising multiple operator control actions related to the operator control elements exceeds a minimum length of time (e.g. seat adjustment). Additionally, it may be inferred that the alertness level of the driver is decreased if operator control inputs known to be cognitively demanding a priori are initiated (e.g. phone).

A disadvantage of the conventional systems and methods is that the driver's alertness is determined or calculated now and then, leading to sudden changes in the alertness level.

Furthermore, the prior art discloses a so-called steering and lane control assist system. The steering and lane control assist system is designed to guide a vehicle substantially centrally in a lane by way of interventions in the lateral guidance of said vehicle. To this end, a camera system captures a lane marking of the lane, with which the vehicle is aligned by way of the interventions in the lateral guidance of the vehicle. If the driver takes his hands off the steering wheel (hands off), a warning asking the driver to return his hands to the steering wheel is output after a predefined period of time.

A disadvantage of conventional steering and lane control assist systems such as these is that the predefined period of time is determined irrespective of an alertness level of the driver and is in particular an invariable length of time.

Against the background of this prior art, the object of the present invention is to provide an apparatus and a method that are each suitable for overcoming at least the aforementioned disadvantages of the prior art.

The object is achieved by the features of the independent claim. The subclaims contain preferred developments of the invention.

Accordingly, the object is achieved by a method for determining a hands-off time for an automated motor vehicle, wherein the hands-off time is determined on the basis of an alertness level of a driver of the motor vehicle over time.

In other words, a period of time or spell for which the driver does not need to have his hands on the steering wheel (so-called hands-off time) is determined not only by now and then determining the alertness level of the driver, but also by considering an alertness level of the driver from the past, so as thus to determine the present alertness level and hence the alertness level that is critical for the hands-off time.

That is to say that the (present) hands-off time is determined on the basis of an alertness level value, which is in turn determined on the basis of a present alertness of the driver and an alertness of the driver that was determined before the present alertness of the driver was determined. These are also included as historical data.

The hands-off time may be the period of time for which the driver may take his hands off the steering wheel without a warning being output.

The alertness level of the driver may be determined on the basis of visual, auditive, and/or haptic sensor data.

It is embodied for visual sensor data to be captured by virtue of there being provided an interior camera pointed at the driver.

It is embodied for auditive sensor data to be captured by virtue of there being provided an interior microphone that captures sounds in the interior of the motor vehicle.

It is embodied for the haptic sensor data to be captured by virtue of a touch-sensitive sensor arrangement being arranged in the motor vehicle interior, in particular on a steering apparatus and/or another arm or hand rest in the motor vehicle interior.

The alertness level may be determined on the basis of a behavior of the driver.

The behavior of the driver may be determined by determining a predefined positive behavior of the driver that leads to an increase in alertness level, and by determining a predefined negative behavior of the driver that leads to a decrease in alertness level.

The predefined positive behavior and/or the predefined negative behavior of the driver may be determined on the basis of a tiredness of the driver and/or a line of vision of the driver.

It is embodied for a tiredness of the driver to be determined on the basis of a blink analysis, in particular on the basis of an eyelid closure time and/or a blink rate.

The behavior of the driver may be determined at discrete times and/or continuously.

A high alertness level of the driver may lead to a longer hands-off time than a low alertness level of the driver.

A steering and lane control assist system may be activated while the method is carried out.

The steering and lane control assist system may be a driving assistance system as described at the outset that intervenes in lateral guidance of the motor vehicle and thereby keeps said vehicle in a lane and optionally facilitates automated lane changing.

It is embodied for an adaptive cruise control system to be activated in addition or as an alternative to the steering and lane control assist system while the method is carried out. The adaptive cruise control system may be designed to at least intermittently and/or partially take over longitudinal guidance of the motor vehicle, in particular such that the motor vehicle follows a motor vehicle travelling ahead.

The aspects described above can be summarized in a specific embodiment and in other words as described below.

A camera in the interior of the motor vehicle is used to continuously observe the driver, and the data captured by the camera are taken as a basis for calculating a present score value for the alertness of the driver, in particular now and then.

The present alertness or the present alertness level of the driver is ascertained on the basis of this present score value and the previously calculated score values.

Various weights for the present score value in relation to the previously calculated score values are conceivable in this case. In particular, it is thus possible to calculate a trend for the alertness level over an entire journey time, and said trend permits shorter or longer hands-off times depending on its level.

Both a positive behavior of the driver, e.g. if the driver is constantly alert, and a negative behavior of the driver, e.g. if the driver pushes system limits, and/or tiredness of the driver, are thus captured.

The positive behavior allows longer hands-off times and is rewarded. The negative behavior decreases the hands-off time and is penalized.

Further, a control unit for a motor vehicle is provided, wherein the control unit is designed to carry out at least part of the method described above.

It is contemplated, in addition or as an alternative, for a motor vehicle comprising the control unit to be provided. The motor vehicle may be an automobile.

The aspects described above with reference to the method also apply analogously to the control unit and the motor vehicle, and vice versa.

An embodiment is described below with reference to FIG. 1.

### BRIEF DESCRIPTION OF THE DRAWING

FIG. 1 schematically shows a trend for an alertness level of a driver of the motor vehicle over time that is determined using the method for determining a hands-off time.

### DETAILED DESCRIPTION OF THE DRAWING

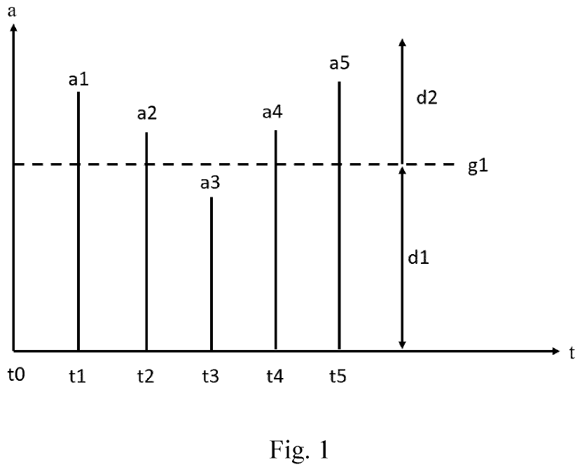

FIG. 1 shows a graph, the horizontal axis of which plots time t and the vertical axis of which plots alertness level a.

By way of illustration, FIG. 1 plots five alertness level values a1-a5, determined at the times t1-t5, that have been determined using the method for determining the hands-off time for an automated motor vehicle.

The alertness level a is accordingly determined at discrete times and represented by the alertness level values a1-a5, continuous determination of the alertness level a also being contemplated in addition or as an alternative.

Furthermore, FIG. 1 shows a limit value g1 for the alertness level a, the hands-off time being a first length or period of time d1 if the alertness level a is below the limit value g1, and the hands-off time being a second length or period of time d2 if the alertness level a is the same as the limit value g1 or is above the limit value g1.

The first period of time d1 is shorter than the second period of time d2, i.e. a high alertness level a of the driver leads to a longer hands-off time than a low alertness level a of the driver.

The timeline t begins at the time to, at which a journey in the automated motor vehicle is begun, a steering and lane control assist system of the motor vehicle being activated at the time at which the method is carried out.

The method is carried out by a control unit installed in the motor vehicle that is designed to output a warning, in particular auditively, tactilely and/or visually, to the driver if the first or the second period of time d1, d2, i.e. the determined hands-off time, is exceeded.

The method is based on the concept that the hands-off time is determined on the basis of the alertness level a of the driver of the motor vehicle over time t, i.e. a present alertness level value a1-a5 is determined by considering at least the alertness level value a1-a5 of the previous determination.

In the present case, the alertness level value a1-a5 is determined by determining a score value for the alertness of the driver at the respective determination time t1-t5.

This score value is determined on the basis of the behavior of the driver at the respective time t1-t5, this being accomplished by capturing the behavior of the driver visually by means of an interior camera.

It would also be possible to determine the behavior on the basis of auditive, and/or haptic sensor data in addition or as an alternative.

To this end, the image data from the camera are used to analyze a movement of the driver, in particular a head and/or eye movement to determine a line of vision of the driver and/or an eyelid movement to determine a tiredness of the driver.

Here, a distinction is drawn between a predefined positive behavior of the driver, which leads to an increase in the score value for alertness, and a predefined negative behavior of the driver, which leads to a decrease in the score value for alertness a.

By way of example, the driver's line of vision being turned away from the driving and/or a tiredness exceeding a predetermined or predefined tiredness limit value each lead, as a predefined negative behavior, to a low score value for alertness at the respective determination time t1-t5, whereas the driver's line of vision being turned toward the driving and/or a tiredness below a predetermined or predefined tiredness limit value each lead, as a predefined positive behavior, to a higher score value for alertness at the respective determination time t1-t5.

However, the score value for alertness a that is determined at the respective determination time t1-t5 does not yield the respective alertness level value a1-a5, which ultimately stipulates the length d1, d2 of the hands-off time, on its own.

Rather, the score value for alertness that was ascertained at the time t1 is considered at the time t2 when determining the alertness level value a2, which corresponds to the present alertness level a at the time t2.

The same applies to determination of the alertness level value a3 at the time t3, at which the score value for alertness that was ascertained at the time t1 and/or the score value for alertness that was ascertained at the time t2 are considered for the determination.

It is embodied for score values farther in the past, here the score value at the time t1, to be provided with a low weight for determining the present score value than recently determined score values, here the score value at the time t2. The score values at the times t4 and t5 are determined in the same way.

This allows sharp sudden changes in the alertness level values a1-a5 to be avoided, as can be seen from FIG. 1. Despite the falling score value from the time t1 to the time t2, the alertness level a does not drop below the limit value g1 immediately at the time t2, but rather only at the time t3, and then increases again up to the time t5.

It is thus possible for a positive behavior of the driver from the past to be considered and honored with a longer hands-off time, even if the score value for alertness at a determination time t1-t5, for example randomly, does not justify a longer hands-off time such as this, and vice versa.

### LIST OF REFERENCE SIGNS

a alertness level
a1-a5 alertness level values
d1 shorter length of hands-off time
d2 longer length of hands-off time
g1 limit value
t time
t1-t5 determination times for alertness level

1.-10. (canceled)

11. A method for determining a hands-off time for an automated motor vehicle, comprising:
determining an alertness level of a driver of the motor vehicle over time; and
determining the hands-off time based on the alertness level of a driver of the motor vehicle determined over time.

12. The method according to claim 11, wherein
the alertness level of the driver is determined based on visual, auditive, and/or haptic sensor data.

13. The method according to claim 12, wherein
the alertness level of the driver is determined based on a behavior of the driver.

14. The method according to claim 11, wherein
the alertness level of the driver is determined based on a behavior of the driver.

15. The method according to claim 14, wherein
the behavior of the driver is determined by determining a predefined positive behavior of the driver that leads to an increase in alertness level, and by determining a predefined negative behavior of the driver that leads to a decrease in alertness level.

16. The method according to claim 15, wherein
the predefined positive behavior and/or the predefined negative behavior of the driver is/are determined based on a tiredness of the driver and/or a line of vision of the driver.

17. The method according to claim 16, wherein
the tiredness of the driver is determined based on a blink analysis.

18. The method according to claim 13, wherein
the behavior of the driver is determined at discrete times and/or continuously.

19. The method according to claim 11, wherein
a high alertness level of the driver leads to a longer hands-off time than a low alertness level of the driver.

20. The method according to claim 11, wherein
a steering and lane control assist system is activated while carrying out the method.

21. A system for a motor vehicle, comprising:
a control unit that determines a hands-off time for an automated motor vehicle, the control unit being operatively configured to:
determine an alertness level of a driver of the motor vehicle over time; and
determine the hands-off time based on the alertness level of a driver of the motor vehicle determined over time determine.
